(19) United States
(12) Patent Application Publication
(10) Pub. No.: US 2015/0234727 A1
(43) Pub. Date: Aug. 20, 2015

(54) Sound Responsive, Bright Illuminating Badge

(71) Applicant: Jason Rubadue, Sammamish, WA (US)

(72) Inventor: Jason Rubadue, Sammamish, WA (US)

(21) Appl. No.: 14/566,260

(22) Filed: Dec. 10, 2014

Related U.S. Application Data
(60) Provisional application No. 62/034,628, filed on Aug. 7, 2014.
(60) Provisional application No. 61/932,431, filed on Jan. 28, 2014.

(51) Int. Cl. G06F 11/32; F21V 23/04; F21V 33/00; H04R 1/04; F21V 3/04; G09F 9/33; H04R 1/02; F21V 23/00; F21L 4/08

(52) U.S. Cl. CPC G06F 11/325; F21V 23/005; F21V 23/0485; F21V 33/0056; F21V 33/008; F21L 4/08; F21V 3/049; G09F 9/33; H04R 1/028; H04R 1/04; F21Y 2105/001

(57) ABSTRACT

A sound responsive, bright illuminated badge that includes an opaque outer body with a front opening or window. Located inside the front opening is an image panel. Located below the image panel is a translucent front case. A planar LED mounting board is located below the front case and includes a plurality of inward oriented LEDs aligned in a row adjacent to one end of the mounting board. The top surface of the LED mounting board includes a layer of reflective material. Disposed over the layer of reflective material is a light diffuser panel. The badge's PCB includes a decibel regulator that connects to a built-in microphone that varies the blinking speed of the LEDs according to the loudness of the ambient noise. The badge also includes a high capacity rechargeable lithium ion battery that provides at least 800 cd/m̂2 at max brightness. The badge includes an external switch that enables the user to manually turn ON and OFF the badge, adjust the brightness level, to select a stead on or a blinking pattern that automatically adjusts based on ambient noise levels.

This utility patent application is based on and claims the filing date benefit of U.S. provisional patent Application No. 62/034,628 filed on Aug. 7, 2014 and U.S. provisional patent Application No. 61/932,431 filed on Jan. 28, 2014.

Notice is given that the following patent document contains original material subject to copyright protection. The copyright owner has no objection to the facsimile or digital download reproduction of all or part of the patent document, but otherwise reserves all copyrights.

### BACKGROUND OF THE INVENTION

1. Field of the Invention

This invention pertains to badges with illuminated displays worn by individuals, and more particularly to such badges wherein the brightness of the display automatically adjusts to ambient sounds.

2. Description of the Related Art

Fans who attend sporting events in large stadiums and arenas enjoy wearing hats, jerseys, coats, scarves, and gloves or holding accessories, such as banners or megaphones, that show support for their favorite team. Items that are unique, small and easy to carry into the stadium or arena, and are easily to operate and do not interfere with other fans, are especially desirable.

In the past, it is well known for fans in a stadium and arena to hold up colored cards at a particular moment during a game top show support but also to distract opposing players on the field. At other times, the cards were used to create a message or a visual effect in one section of the stadium or arena for other fans in the stadium or arena or to an outside television viewing audience.

More recently at football, it has become popular for fans to make loud noises that distract the opposing team or disrupt communications. Operators of the stadiums and arenas often show on large overhead screens decibel loudness graphs that screaming fans can watch to increase the loudness.

What is needed is a small, portable badge that can be worn by sports fans to a stadium or arena with has a bright illuminated display that may be selectively altered by the fan or programmed to change the image on the display or its brightness in response to ambient noise.

### SUMMARY OF THE INVENTION

Disclosed herein is a bright, sound responsive illuminating badge that can be used by sports fans (or other individuals) that uses a bank of LEDs to produce an evenly dispersed, bright light through a fixed or replaceable image panel. In one embodiment, the badge includes a lightweight outer body with a bright back lit front display disposed over the outer body's front opening. The front display is made of translucent material with indicia printed thereon. More specifically, located inside the outer body adjacent to the front display is a light dispersing panel that evenly disperses light from the bank of LEDs. Located inside the outer body and adjacent to the light dispersing panel is a PCB with a plurality of LEDs extending perpendicularly from the PCB's front surface. Mounted on the PCB is an IC, an inductor, a battery connector plug, a USB or power connector plug, and a main ON/OFF switch. In one embodiment, the PCB also includes a mode circuit, an optional dimmer circuit, an optional decibel regulator, an optional microphone and an optional Bluetooth transceiver. Mounted inside the outer body is a rechargeable lithium ion battery.

In the first embodiment, the light dispersing panel includes at least one fence mounted on its back surface that divides the space located between the LEDs and the light dispersing panel into cavities illuminated only by the LEDs. This allows the indicia printed on the front display to be different colors or have different transparent or opaque characteristics.

In a second embodiment, the outer body includes a front frame disposed over an outer housing base. Formed on the front frame is a relatively large front opening. Formed on the side of the outer body is a slot that allows a replaceable image panel to be inserted laterally into the outer body and under the front frame. The image panel is relatively thin structure and is made of transparent material with the user desired indicia printed thereon. Located below the front opening is a planar, translucent front case.

In the second embodiment, an LED mounting board is located below the transparent front case. The LED mounting board includes a plurality of inward oriented LEDs aligned in a row adjacent to one end of the LED mounting board. The top surface of the LED mounting board includes a layer of reflective material so that light from the LEDS is reflected upward from the LED mounting board. Disposed over the layer of reflective material is a light diffuser panel. Because the longitudinal axis of each LED is oriented inward and parallel to the top surface of the LED mounting board, light from each LED is transmitted laterally into the light diffuser panel. The light diffuser panel then reflects the light evenly through the image panel and through the front frame's front opening. Disposed over the top surfaces of the LEDs and adjacent to the light diffuser panel is a flat elongated opaque shield that blocks the upward transmission of light from the LEDs directly above the LEDs.

Located adjacent to the LED mounting board is a printed circuit board (PCB). The PCB is aligned parallel with the top surface of the front frame and includes a capacitive touch button. When assemble, the capacitive touch button is aligned under a contact area formed on the front frame adjacent to the front opening.

The capacitive touch button is part of a capacitive touch circuit formed on the PCB. The button and circuit enables the user to: (1) adjust illumination of the LEDs and, (2) to turn the badge ON or OFF. The PCB also includes a decibel regulator that connects to a microphone. The capacitive touch circuit and the decibel regulator are connected to the microprocessor. The capacitive touch button is used to manually activate and deactivate the decibel regulator. When the device is activated, the microprocessor senses the capacitive touch button to change the device modes between blinking and steady, and change the brightness stages of the LEDs. When in placed in the blinking mode, the microprocessor senses the decibel level sensing circuit to automatically determine how fast the LEDs blink. No user action is required

The badge includes a high capacity rechargeable lithium ion battery that fits inside a recess battery cavity formed in the outer housing base. The LEDs and the lithium ion battery are configured to provide at least 800 cd/m̂2 at max brightness.

The outer body is attached to a lanyard allowing the badge to be hung over the user's chest.

### DESCRIPTION OF THE DRAWINGS

FIG. 1 is a perspective view of a first embodiment of a bright illuminating badge.

FIG. 2 is a front plan view of the illuminating badge shown in FIG. 1

FIG. 3 is a side elevational view of the illuminating badge shown in FIGS. 1 and 2.

FIG. 4 is an exploded perspective view of the illuminating badge showing the relative locations of the components.

FIG. 5 is a sectional top end view of the illuminating badge taken along line 5-5 in FIG. 1.

FIG. 6 is a perspective view of an alternative light dispersion panel with a vertical blocking fence attached to its inside surface.

FIG. 7 is an exploded, perspective view of a second embodiment of the bright illuminating badge.

FIG. 8 is a top perspective view of the LED mounting board used in the illuminating badge shown in FIG. 7.

FIG. 9 is a top plan view of the illuminating badge shown in FIG. 7.

FIG. 10 is a bottom plan view of the illuminating badge shown in FIG. 7.

FIG. 11 is a right side elevational view of the illuminating badge shown in FIG. 7.

FIG. 12 is a left side elevational view of the illuminating badge shown in FIG. 7.

FIG. 13 is a front elevational view of the illuminating badge shown in FIG. 7.

FIG. 14 is a plan view of the printed circuit board (PCB) used in the second embodiment of the illuminating badge.

FIG. 15 is an electrical schematic of the embodiment of the illuminating badge shown in FIG. 7.

FIG. 16 is an illustration of a user with the second embodiment of the illuminating badge attached to a lanyard and hung over the user's chest.

### DESCRIPTION OF THE PREFERRED EMBODIMENT(S)

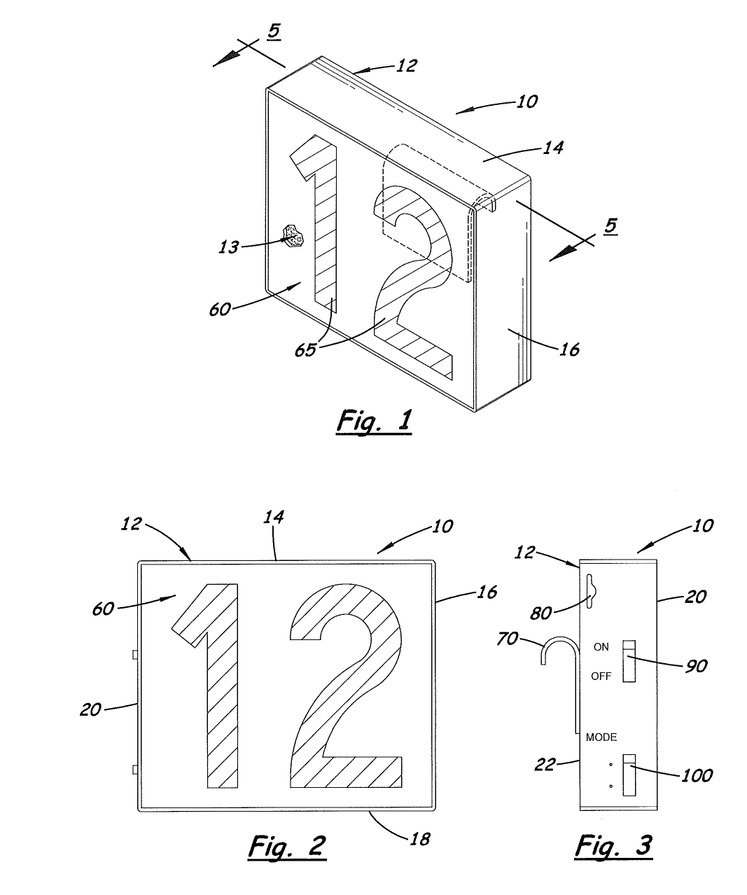

FIG. 1 is a perspective view of a first embodiment of an illuminating badge indicated by the reference number 10. The badge 10 is described as being used by sports fans at a stadium or arena. It should be understood, however, that the badge 10 may be used by other users in different settings and environments.

The badge 10 that includes a translucent outer body 12 with bright back lit front display 60 disposed over the outer body's front opening 13. In the embodiment shown in the Figs, the outer body 12 is square or rectangular and includes a top panel 14, a right side panel 16, a bottom panel 18, a left side panel 20 and a rear panel 22. Mounted on the rear panel is a clip 70. Printed on the front display 50 are clear, colored, translucent, or opaque indicia 65. It should be understood that the shape of the outer body 12 may be polygonal, circular, oval, or oblong.

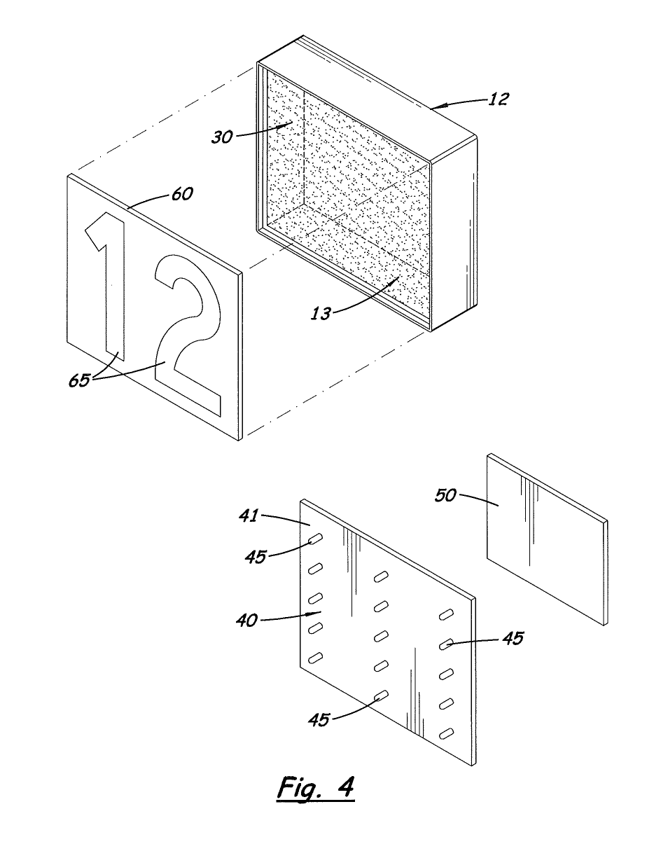

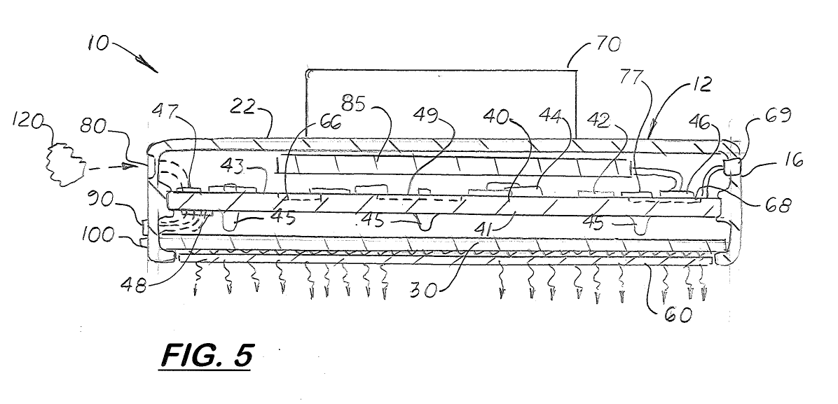

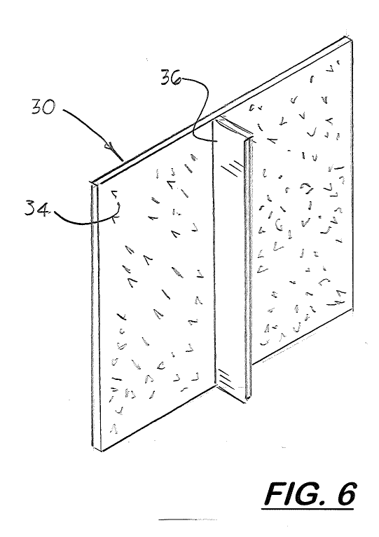

As shown more clearly in FIGS. 4 and 5, located inside the outer body 12 adjacent to the front display 60 is a planar, light dispersing panel 30. Located inside the outer body 12 and parallel and adjacent to the light dispersing panel 30 is a planar PCB 40 with a plurality of LED s 45 extending perpendicularly from the PCB's front surface 41. Mounted on the rear surface 43 on the PCB 40 are an IC 44, an inductor 42, a battery connector plug 46, a USB connector plug 47, and a main ON/OFF switch 48. In one embodiment, the PCB 40 includes an optional mode circuit 49, an optional dimmer circuit 66, an optional decibel regulator circuit 68, an optional microphone 69, and a Bluetooth transceiver 77. Mounted inside the outer body is a rechargeable lithium ion battery 85.

Mounted on the left side panel 20 is an a USB port 80, an external main switch 90, and an external switch 100, The USB port 80 may be used to charge the battery 85 or used to download a software program 120 that enables a computer or smart phone (not shown) to communicate with the badge 10.

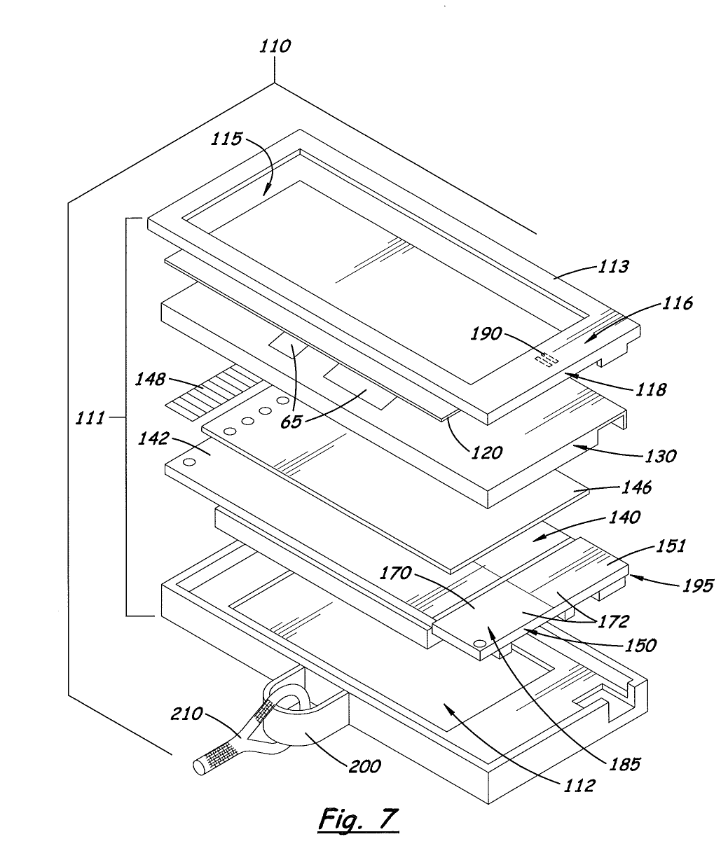

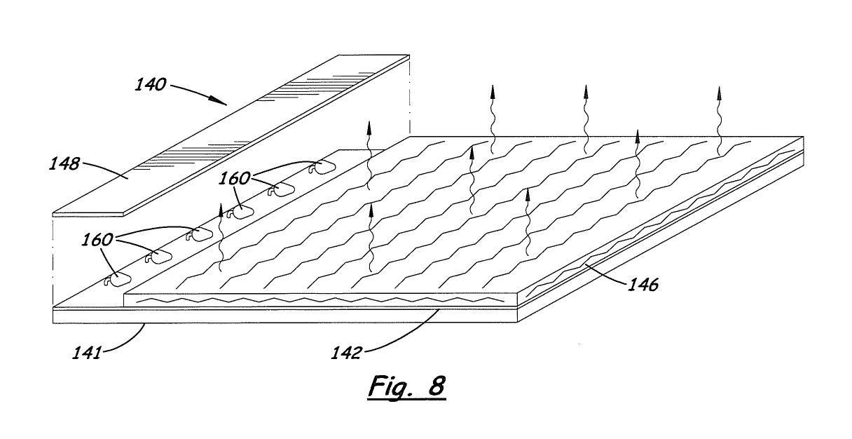

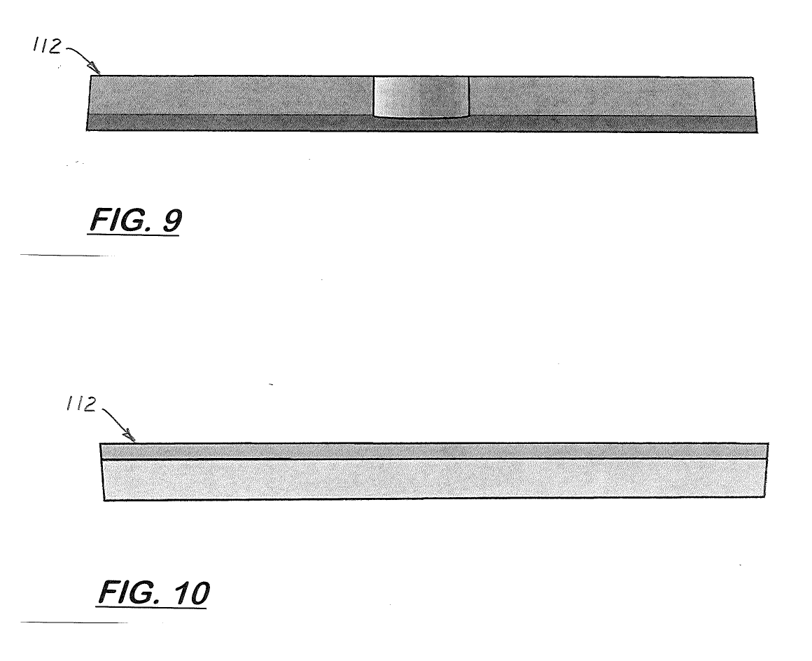

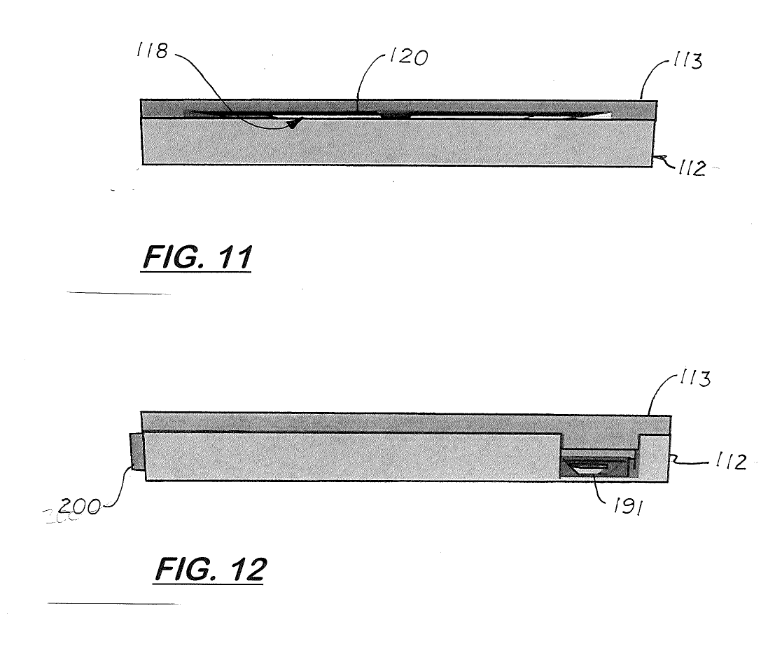

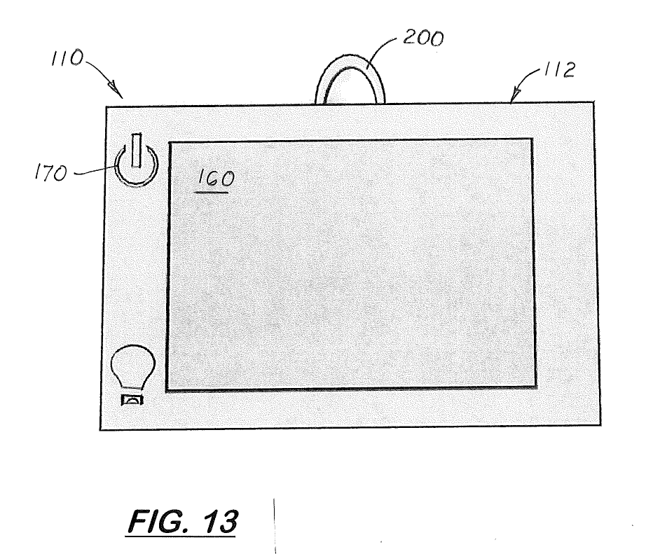

FIGS. 7-16 are views of a second embodiment of the bright LED badge (denoted by reference number 110) that includes an opaque outer body 111 with a square or rectangular front opening 115. The badge 110 includes a square or rectangular shaped, hollow outer body 111 that includes a lower outer housing base 112 that attaches to a front frame 113. When the front frame 113 is closed over the outer housing base 112, a cavity is formed which houses all of the badge's electrical components. When the front frame 113 is attached to the outer housing base 112, a card slot 118 is formed on one side of the outer body 111. Fed into the card slot 118 is a replaceable image panel 120 that extends transversely into the outer housing base 112. Printed on the image panel 120 is the user desired indicia 65.

Located inside the outer body 111 and below the image panel 120 is a translucent front case 130. The front case 130 is a planar structure slightly smaller in width and length than the outer body 111.

Located below the front case 130 is a thin, planar LED mounting board 140. The LED mounting board 140 includes a rigid substrate board 141 with a plurality of inward oriented LEDs 160 aligned in a row adjacent to one edge of the substrate board 141. The top surface of the substrate board 141 includes a layer of reflective material 142. Disposed over the layer of reflective material 142 is a light diffuser panel 146. Because the longitudinal axis of each LED 160 is oriented inward and parallel to the top surface of the substrate board 141, light from each LED is transmitted laterally into the edge of the diffuser panel 146. The diffuser panel 146 then transmits the light evenly and reflects it perpendicular upward through the front case 130, the image panel 120 and through the front opening 115. Disposed over the top surfaces of the LEDs 160 and adjacent to the light diffuser panel 146 is a flat elongated, opaque shield 148 that blocks the upward transmission of light from the LEDs 160.

Attached to the edge of the LED mounting board 140 opposite the LEDs 160 is a printed circuit board (PCB) 150. When mounted inside the outer body 111, the PCB 150 is aligned so its top surface 151 is parallel to the front frame 113. Formed on the PCB 150 is at least one capacitive touch button 170. When assembled, the capacitive touch button 170 is aligned under the plastic, pliable touch button formed on the front frame 113 adjacent to the front opening 115.

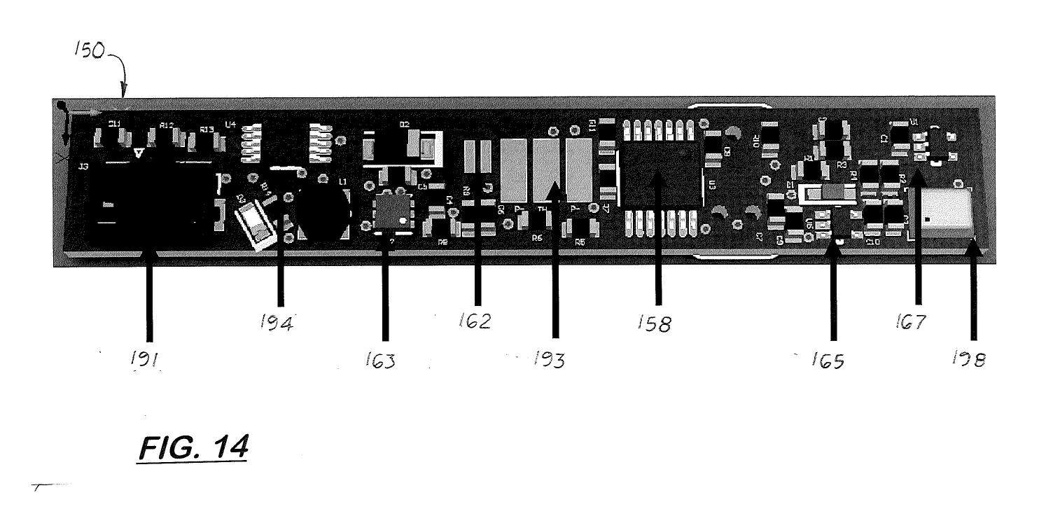

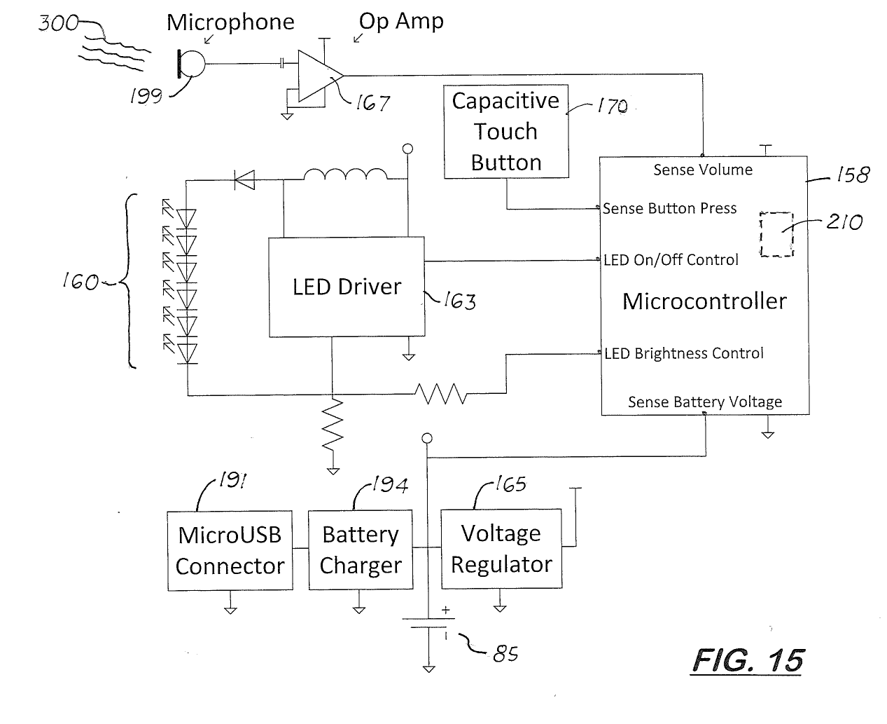

FIG. 14 is a plan view of the PCB 150 and FIG. 15 is a schematic drawing of badge's electrical circuits and components. The PCB 150 includes a decibel regulator 180 and a microphone circuit 198 that includes a built-in microphone 199. During use, the decibel regulator 165 adjusts the blinking speed of the LED bulbs 160 according to the loudness of the ambient noise 300 sensed by the microphone 199. The PCB 150 may also include a battery charger 194 connected to a MicroUSB connector 191. The MicroUSB connector 191 may be connected to a USB cable and used to program the microprocessor 158 on the PCB 150. Mounted or connected to the PCB 150 is an optional charging port 191 that connects to a battery charger 194.

Also mounted or formed on the PCB 150 is a LED driver 163, LED wire pads 162, battery wire pads 193, a microprocessor 158 a voltage regulator 165, an OP-Amp 167 and a built-in microphone 198.

The badge 110 includes a high capacity rechargeable lithium ion battery 194 that fits inside a recess battery cavity formed on the outer housing base 112. The LEDs 160 and the lithium ion battery 194 are configured to provide at least 800 cd/m̂2 at max brightness.

More specifically, the battery 194 is a flat, rechargeable polymer lithium ion battery 2.6 mm thick and can provide up to 1 W of power to the LEDs 160 during operation. By using 1 W of power, a plurality of LEDs may be driven with greater brightness. The capacity of the battery 194 is relatively large that allows the LEDs 160 to remain illuminated with greater brightness for several hours

As shown in FIG. 15, the microcontroller 158 is connected to an Op-Amp 167 which is connected to the built-in microphone 198. The microcontroller 158 is connected to the capacitive touch button 170 which is positioned directly below one of the touch surfaces formed on the front frame 115. Also mounted on the PCB is an internal LED driver 163 and an electrical power subsystem 190 that includes the lithium battery 85, the voltage regulator 165, lithium battery compatible battery charger 194, and the MicroUSB port connector 191.

During operation, the capacitive touch button 170 may be pressed to change the device's one of six of the following operational modes: Mode 0=Off; Mode 1=On, blinking, high brightness (blinking frequency increases with high decibel levels); Mode 2=On, blinking, medium brightness (blinking frequency increases with high decibel levels); Mode 3=On, steady, high Brightness; Mode 4 ON, steady, medium brightness; and Mode 5=On, steady, low brightness.

To enable the LED blinking patterns, the microcontroller 158 first senses the volume from the microphone 198 and the Op-Amp 167. The microcontroller 158 then controls the LED driver 163 in two ways based on the algorithm used in the microcontroller 158: first the microcontroller 158 turns on/off the LED driver 163 to select a desired blinking pattern; and second, the microcontroller 158 adjusts the brightness of LEDs 160 by adjusting the current through the LEDs 160. The Op-Amp 167 increases the gain of the signal from the microphone 198 so that it can be sensed by the microcontroller 158.

In the embodiment shown herein, the built-in microphone 198 is contained within the outer case 112 that allows sound waves to penetrate.

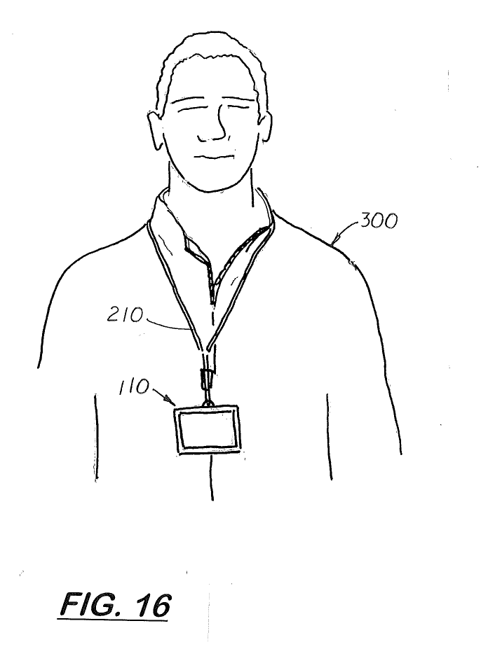

The outer body 112 includes a U-shaped clip 200 is attached to a lanyard 210 allowing the badge 110 to be hung over the chest of a user 300 as shown in FIG. 16.

As stated above, the device may or may not include a wireless transmitter. If a wireless transmitter is desired, then the microcontroller shown in FIG. 15 may be replaced by a microcontroller with an integrated Bluetooth.

As stated above, capacitive touch button 170 acts as a mode switch that enables the user to: (1) adjust color and pattern of illumination of the LEDs and (2) to turn the badge ON or OFF, (3) to regulate brightness (4) and to regulate the blinking speed of the LEDs based on ambient noise level. When setup properly, the desired image panel will be used, the LED color and pattern will be selected, and the brightness of the LEDs will be automatically adjusted according to the loudness of the ambient noise.

In compliance with the statute, the invention described has been described in language more or less specific as to structural features. It should be understood however, that the invention is not limited to the specific features shown, since the means and construction shown, comprises the preferred embodiments for putting the invention into effect. The invention is therefore claimed in its forms or modifications within the legitimate and valid scope of the amended claims, appropriately interpreted under the doctrine of equivalents.

I claim:

1. A sound responsive, illuminating badge, comprising:
a. a thin outer body with a top panel, a bottom panel, two side panels with an inner cavity formed therein, said top panel includes a front opening leading to said inner cavity, said outer body includes a thin card slot on one of said side panel and near said front opening;
b. a planar translucent front case located inside the outer body and below the image panel;
c. a planar LED mounting board is located below the front case and includes a plurality of inward oriented LEDs aligned in a row adjacent to one end of the LED mounting board;
d. a PCB located inside said inside cavity, said PCB includes one or more capacitive touch button, said PCB includes a rechargeable battery charging circuit, a decibel regulator circuit and a battery charging port;
e. a microphone connected to said decibel regulator circuit;
f. a rechargeable lithium ion battery located inside said inner cavity and connected to said PCB and said LEDs, said lithium ion battery producing at least 800 cd/m̂2 at max brightness; and,
g. a microprocessor connected to said PCB and configured to automatically adjust the blinking speed of said LED's based on the ambient sounds received by said microphone.

2. The illuminated badge, as recited in claim 1 further including a touch capacitive button connected to said PCB that activates and deactivates said badge and selectively changes said LEDs from a steady on to a blinking operation.

3. The illuminated badge, as recited in claim 2, wherein said microprocessor is configured to increase the blinking frequency when the ambient noise becomes louder.

4. A sound responsive, illuminating badge, comprising:
a. a thin outer body with a top panel, a bottom panel, two side panels with an inner cavity formed therein, said top panel includes a front opening leading to said inner cavity;
b. an external switch;
c. a planar translucent front case located inside the outer body and below said front opening on said top panel;
d. a planar LED mounting board is located below the front case that includes a plurality of LEDs, said LEDs connected to an LED driver;
e. a PCB located inside said inside cavity; said PCB includes a sense battery voltage circuit;
f. a battery charger connected to said sense battery voltage circuit;
g. a decibel regulator;
h. a microphone connected to said decibel regulator;
i. a rechargeable lithium ion battery connected to said PCB and said battery charger, and;
j. a microprocessor mounted on said PCB, said microprocessor connected to said LED mounting board, to said microphone, to said said decibel regulator, and to said external switch, said microprocessor configured to control the LED's in one of following 5 modes (0-5) of operation: Mode 0=Off; Mode 1=On, blinking, high brightness (blinking frequency increases with high decibel levels); Mode 2=On, blinking, medium brightness (blinking frequency increases with high decibel levels); Mode 3=On, steady, high Brightness; Mode 4 ON, steady, medium brightness; and Mode 5=On, steady, low brightness.

5. The illuminated badge, as recited in claim 4, further including a diffuser panel located above said LEDs and under said front case.

6. The illuminated badge, as recited in claim 6, further including an image panel located above said diffuser panel and under said front case.

7. The illuminated badge, as recited in claim 4, further including an image panel located under said front case.

8. The illuminating badge, as recited in claim 4, wherein said battery and LEDs are configured to provide at least 800 cd/m̂2 at max brightness.

9. The illuminating badge, as recited in claim 5, wherein said battery and LEDs are configured to provide at least 800 cd/m̂2 at max brightness.

10. The illuminating badge, as recited in claim 6, wherein said battery and LEDs are configured to provide at least 800 cd/m̂2 at max brightness.
